(19) United States
(12) Patent Application Publication
(10) Pub. No.: US 2021/0006930 A1
(43) Pub. Date: Jan. 7, 2021

(54) INFORMATION PROCESSING APPARATUS, INFORMATION PROCESSING METHOD, INFORMATION PROCESSING SYSTEM AND PROGRAM

(71) Applicant: SONY CORPORATION, Tokyo (JP)

(72) Inventor: Fumihiko IIDA, Kanagawa (JP)

(73) Assignee: SONY CORPORATION, Tokyo (JP)

(21) Appl. No.: 16/977,330

(22) PCT Filed: Feb. 15, 2019
(86) PCT No.: PCT/JP2019/005537

§ 371 Date: Sep. 1, 2020

(30) Foreign Application Priority Data
Mar. 8, 2018 (JP) 2018-041838

(51) Int. Cl. H04S 7/00; H04R 3/12; H04N 9/31

(52) U.S. Cl. CPC H04S 7/40; H04N 9/31; H04R 3/12

(57) ABSTRACT

There is provided an information processing apparatus that selects an appropriate speaker from a plurality of speakers corresponding to positions of projection areas. The information processing apparatus includes a control section that selects a speaker to be used when a projection is performed on a specified projection area from a plurality of speakers on a basis of information about the specified projection area and information about positions of the plurality of speakers from a plurality of projection areas capable of projecting an image.

### TECHNICAL FIELD

The present technology relates a technology that a speaker to be used is selected from the plurality of speakers.

### BACKGROUND ART

In the related art, a projector that can project a video on a screen, a wall, or the like is widely known.

Patent Literature 1 describes a projector that can project a video on any area of a wall or a ceiling by automatically controlling a direction of an optical system in the projector.

According to the technology described in Patent Literature 1, whiteness, unevenness, and the like of an object to be projected are first determined on the basis of the image on which the object to be projected such as a wall is imaged. Then, on the basis of the whiteness, the unevenness, and the like, a projection area candidate that is a candidate of the projection area for projecting a video is determined.

Next, the video is projected on the projection area candidate and the projection area candidate is presented to the user. In a case where the projection area candidate is one, the only one projection area candidate is determined as an actual projection area.

On the other hand, in a case where there are plural projection area candidates and the user instructs to switch the projection area candidate, the candidate is switched to other projection area candidate. Then, the video is projected with respect to the projection area candidate and the projection area candidate is presented to the user. When the user instructs to end while any of the projection area candidates is presented, the current projection area candidate is determined as the actual projection area.

### CITATION LIST

### Patent Literature

Patent Literature 1: Japanese Patent Application Laid-open No. 2015-144344

### DISCLOSURE OF INVENTION

### Technical Problem

If the speakers at the same positions (for example, speakers built in projector) are used for the plural projection areas in different positions, a realistic feeling may be destroyed.

The present technology is made in view of the above-mentioned circumstances, and it is an object of the present technology to provide a technology that an appropriate speaker is selected from a plurality of speakers corresponding to positions of projection areas.

### Solution to Problem

An information processing apparatus according to the present technology includes a control section that selects a speaker to be used when a projection is performed on a specified projection area from a plurality of speakers on the basis of information about the specified projection area and information about positions of the plurality of speakers from a plurality of projection areas capable of projecting an image.

Thus, an appropriate speaker is selected from a plurality of speakers corresponding to positions of projection areas.

In the information processing apparatus, the control section may select the speaker to be used on the basis of a distance between the specified projection area and each speaker.

In the information processing apparatus, the control section may select a speaker that has a distance closest to the specified projection area as the speaker to be used from the plurality of speakers.

In the information processing apparatus, the control section may select two or more speakers as the speaker to be used.

In the information processing apparatus, different voice channels may be allocated to the respective two or more speakers.

In the information processing apparatus, the control section may set a plurality of search areas for searching the speaker and select a speaker to be used for each search area.

In the information processing apparatus, the control section may set the plurality of search areas using a position of the specified projection area as a reference.

In the information processing apparatus, the control section may acquire information about a position of a user and select the speaker to be used on the basis of the information about the position of the user.

In the information processing apparatus, the control section may acquire information about each audible area of the plurality of speakers and select the speaker to be used on the basis of the information about each audible area.

In the information processing apparatus, the control section may determine whether or not the speaker including the position of the user in the search area is present, and, if present, select the speaker including the position of the user in the search area as the speaker to be used.

In the information processing apparatus, if the speaker including the position of the user in the search area is not present, the control section may select the speaker that has the distance closest to a projection area from the plurality of speakers as the speaker to be used.

In the information processing apparatus, the control section may select two or more speakers as the speaker to be used.

In the information processing apparatus, the control section may set a plurality of search areas for searching the speaker and select the speaker to be used for each search area.

In the information processing apparatus, the control section may set the plurality of search areas on the basis of the positions of the user.

In the information processing apparatus, each of the plurality of speakers may have a marker for acquiring the information about the position of the speaker.

In the information processing apparatus, at least one speaker of the plurality of speakers is capable of being held by a user, and the control section may acquire the information about the position of the speaker held by the user and register the projection area on the basis of the information about the position of the speaker.

In the information processing apparatus, the control section may change the position of the projection area.

An information processing system according to the present technology includes a plurality of speakers; and an information processing apparatus, including a control section that selects a speaker to be used when a projection is performed on a specified projection area from the plurality of speakers on the basis of information about the specified projection area and information about positions of the plurality of speakers from a plurality of projection areas capable of projecting an image.

An information processing method according to the present technology includes selecting a speaker to be used when a projection is performed on a specified projection area from the plurality of speakers on the basis of information about the specified projection area and information about positions of the plurality of speakers from a plurality of projection areas capable of projecting an image.

A program according to the present technology functions a computer as a control section that selects a speaker to be used when a projection is performed on a specified projection area from a plurality of speakers on the basis of information about the specified projection area and information about positions of the plurality of speakers from a plurality of projection areas capable of projecting an image.

### Advantageous Effects of Invention

As described above, according to the present technology, there can be provided a technology that an appropriate speaker is selected from a plurality of speakers corresponding to positions of projection areas.

### BRIEF DESCRIPTION OF DRAWINGS

FIG. 1 is a diagram showing an information processing system according to a first embodiment of the present technology.

FIG. 2 is a block diagram showing the information processing system.

FIG. 3 is an enlarged view showing a speaker.

FIG. 4 is a flowchart showing processing of registering a projection area.

FIG. 5 shows a state that a user holds a speaker and registers a projection area.

FIG. 6 shows an example of positions of a plurality of projection areas registered in a room.

FIG. 7 shows an example of coordinates of the plurality of projection areas.

FIG. 8 shows an example of a coordinate of each speaker.

FIG. 9 is a flowchart showing processing of selecting the speaker.

FIG. 10 is a flowchart showing processing of selecting a speaker in a second embodiment.

FIG. 11 shows a plurality of search areas set on the basis of a projection area coordinate system.

FIG. 12 shows a state that a voice channel is allocated to any speaker.

FIG. 13 is a flowchart showing processing of selecting a speaker in a third embodiment.

FIG. 14 shows a distance (threshold) from the user.

FIG. 15 shows an example of an audible area.

FIG. 16 is a flowchart showing processing of selecting a speaker in a fourth embodiment.

FIG. 17 shows a state that each audible area is set to each speaker.

FIG. 18 is a flowchart showing processing of selecting a speaker in a fifth embodiment.

FIG. 19 shows a plurality of search areas set on the basis of a user coordinate system.

### MODE(S) FOR CARRYING OUT THE INVENTION

Hereinafter, embodiments of the present technology will be described with reference to the drawings.

### First Embodiment

### <Whole and Each Section Structure and Each Section of Information Processing System>

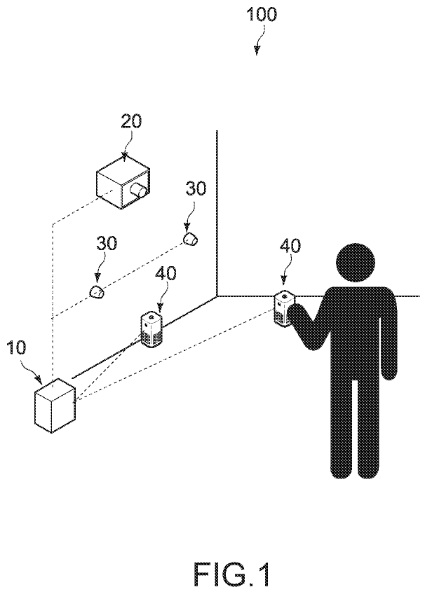

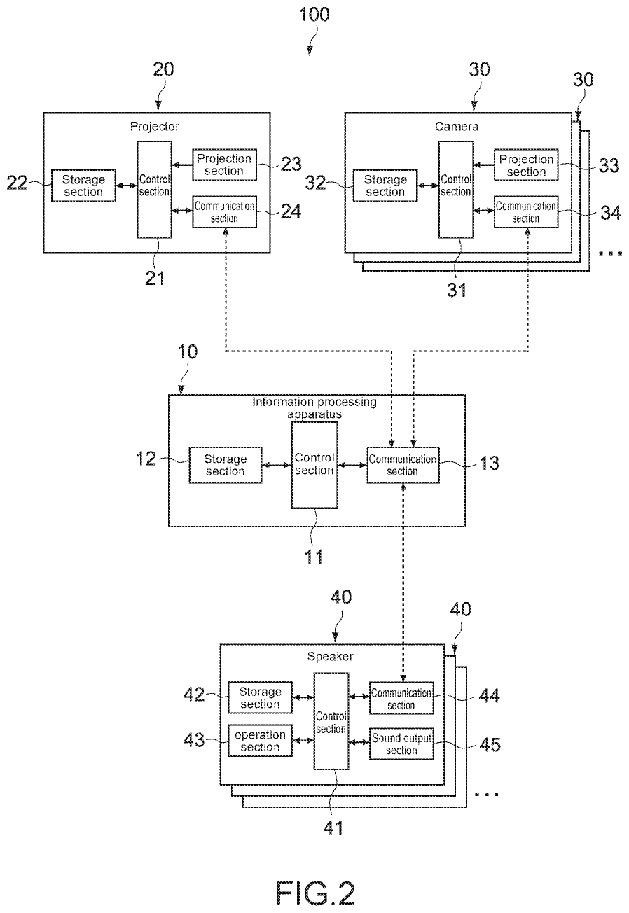

FIG. 1 is a diagram showing an information processing system 100 according to a first embodiment of the present technology. FIG. 2 is a block diagram showing the information processing system 100. As shown in FIGS. 1 and 2, the information processing system 100 includes an information processing apparatus 10, a projector 20, a plurality of cameras 30, and a plurality of speakers 40.

The information processing apparatus 10 executes main controls in an information processing method according to the present technology. The information processing apparatus 10 may be a dedicated apparatus for the information processing system 100 and may be a general purpose apparatus usable for any application other than the information processing system 100. In a case where the general purpose apparatus is used as the information processing apparatus 10, the information processing apparatus 10 includes, for example, a variety of PCs such as a desk top PC (Personal computer), a lap top PC, a tablet PC, a smartphone, a game machine, a music player, and the like. Typically, the information processing apparatus 10 may be any apparatus having an information processing function.

FIG. 1 shows an example state that the information processing apparatus 10 is arranged in a room. On the other hand, the information processing apparatus 10 may be arranged outside of the room (for example, the information processing apparatus 10 may be a server apparatus or the like on a network).

The information processing apparatus 10 includes a control section 11, a storage section 12, and a communication section 13. The control section 11 includes, for example, a CPU (Central Processing Unit) or the like. The control section 11 integratedly controls each section of the information processing apparatus 10 and a whole of the information processing system 100. A variety of processing in the control section 11 will be described in detail in a column named, Operation description, below.

The storage section 12 includes a non-volatile memory in which a variety of data and a variety of programs necessary for processing of the control section 11 and a volatile memory used as a working area of the control section 11. The above-described variety of programs may be read out from a portable recording medium such as a semiconductor memory and an optical disc, or may be downloaded from the server apparatus on the network (the same is applied to a program in other storage section described later).

The communication section 13 is capable of communicating wirelessly or wired with the projector 20, the camera 30, and the plurality of speakers 40 each other.

The projector 20 is capable of projecting an image toward a variety of projection targets in the room such as a wall, a ceiling, a floor, furniture (table, chest, and the like) and a screen. The projector 20 is attached to a posture control mechanism attached at any position in the room, e.g., on a ceiling, on a table, or the like.

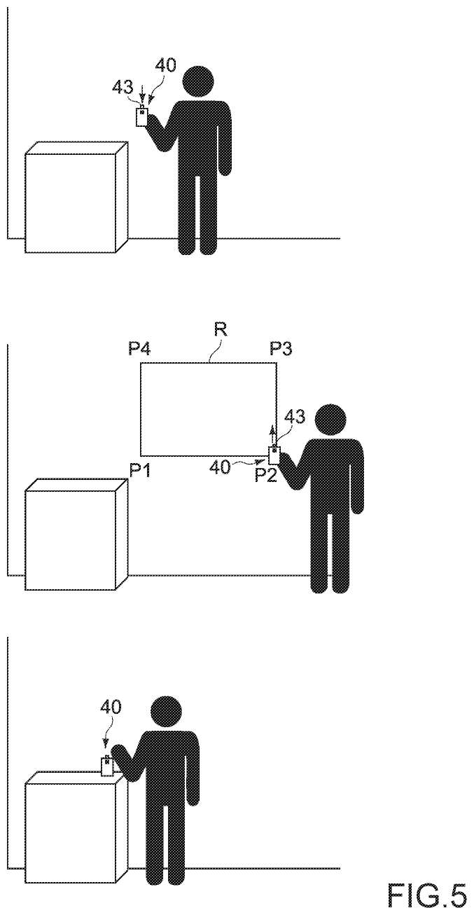

In addition, its direction and posture of the projector 20 is allowed to be adjustable (i.e., movable) optionally by driving the posture control mechanism. By adjusting the direction and the posture, the projector 20 is allowed to project the image on any projection area R in the room (see FIG. 5).

Note that, in the present embodiment, the whole direction and posture of the projector 20 may be changed. On the other hand, the whole direction and posture of the projector 20 may not be changed, and a part of the direction and the posture of the projector 20 (for example, only a projection section 23) may be changed.

The projector 20 includes the control section 21, the storage section 22, the projection section 23, and the communication section 24. The control section 21 includes, for example, the CPU (Central Processing Unit) or the like, and integratedly controls each section of the projector 20.

The storage section 22 includes a non-volatile memory in which a variety of data and a variety of programs necessary for processing of the control section 21 and a volatile memory used as a working area of the control section 21. The communication section 23 is capable of communicating wirelessly or wired with the information processing apparatus 10 each other.

The projection section 23 includes a reflector that generates reflected light of light outgone from a light source, an image conversion device for converting the reflected light to projection light (for example, liquid crystal, a mirror optical system), and a projection lens that projects the projection light. The projection section 23 may include a zoom mechanism and an auto-focus mechanism.

Each of the plurality of cameras 30 acquires an image of the speaker 40, an image of a user, and the like depending on an instruction from the information processing apparatus 10 and transmits the acquired image to the information processing apparatus 10. The plurality of cameras 30 are allowed to be arranged at a little higher position in the room so as to be capable of imaging as wide as possible, for example. Note that each camera 30 may have a configuration that an imageable range is changeable (i.e., movable) by adjusting the direction and the posture.

Each of the plurality of cameras 30 includes the control section 31, the storage section 32, an imaging section 33, and the communication section 34. The control section 31 includes, for example, the CPU (Central Processing Unit) and the like and integratedly controls each section of the cameras 30.

The storage section 32 includes a non-volatile memory in which a variety of data and a variety of programs necessary for processing of the control section 31 and a volatile memory used as a working area of the control section 31. The communication section 34 is capable of communicating wirelessly or wired with the information processing apparatus 10 each other.

The imaging section 33 includes an image sensor such as a CMOS (Complementary Metal Oxide Semiconductor) sensor and a CCD (Charge Coupled Device) sensor and a lens optical system such as an imaging lens that images object light with respect to an exposure surface of the image sensor.

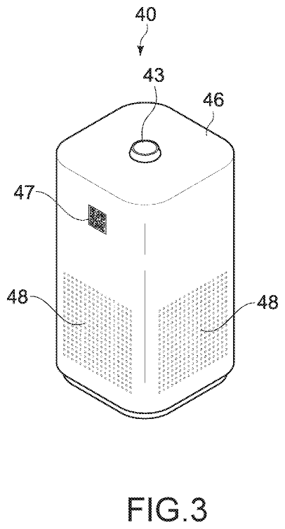

FIG. 3 is an enlarged view showing the speaker 40. The speaker 40 is allowed to have a size and a weight to an extent that the user can hold by one hand and is placed and used by the user at any position in the room.

As shown in FIG. 3, the speaker 40 includes a case 46 that contains a variety of components therein. At lower positions of a front face, a right side face, a back face, and a left side face of the case 46, there are a plurality of small openings 48 for emitting sound generated inside of the case 46 into outside of the case 46.

In addition, at an upper position of the front face of the case 46, a marker 47 is arranged. The marker 47 is arranged in order to ease position recognition of the speaker 40.

FIG. 3 shows an example case that a QR code (registered trademark) is employed as the marker 47. On the other hand, the marker 47 may be a geometric pattern other than the QR code or may be an LED or a laser that emits light in a predetermined frequency. Alternatively, the marker 47 may be a retroreflective material. The marker 47 may typically be any marker 47 that makes easy to recognize the position of the speaker 40.

Furthermore, at a position roughly in the center of the upper face of the case 46, there is arranged an operation section 43 to which an operation by the user is inputted. In this embodiment, the operation section 43 is used to set the projection area R on any area in the room by the user.

FIG. 3 shows an example case that a press button type operation section is utilized as the operation section 43. On the other hand, the operation section 43 may be a touch type operation section by a proximity sensor. Alternatively, the operation section 43 may be a form (microphone) to which the operation of the user is inputted by voice. The operation section 43 may typically be any operation section to which the operation of the user can be inputted.

With reference to FIG. 2, the speaker 40 includes the control section 41, the storage section 42, the operation section 43, the communication section 44, and a sound output section 45.

The control section 41 includes, for example, the CPU (Central Processing Unit) and the like, and integratedly controls each section of the speaker 40.

The storage section 42 includes a non-volatile memory in which a variety of data and a variety of programs necessary for processing of the control section 41 and a volatile memory used as a working area of the control section 41. The communication section 44 is capable of communicating wirelessly or wired with the information processing apparatus 10 each other.

The sound output section 45 converts a sound signal inputted from the control section 41 to physical vibration and generates a sound corresponding to the signal sound. The sound output section 45 may be any type of a sound output section including a cone paper type, a piezoelectric type, an ultrasonic type, and the like.

### <Operation Description>

[Register Processing of Projection Area R]

Next, processing of the control section 11 of the information processing apparatus 10 will be described. In the processing description, processing of the control section 11 of the information processing apparatus 10 to register the projection area R will be first described.

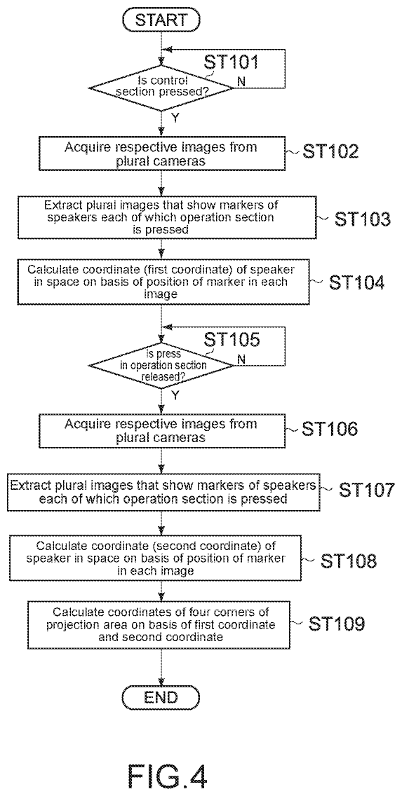

FIG. 4 is a flowchart showing the processing of registering the projection area R. FIG. 5 shows a state that the user holds the speaker 40 and registers the projection area R.

In FIG. 5, as shown in an upper diagram, the user first looks for any place where the projection area R is to be registered in a space of the room, holds the speaker 40, and moves to the place. The upper diagram of FIG. 5 shows a state that the user stands by the wall by trying to register a part of the wall as the projection area R. Note that the projection area R is not limited to the wall and a ceiling, a floor, furniture (table, chest, and the like), a screen and or the like can be registered.

After the user holds the speaker 40 and moves to the any place, the user positions the speaker 40 at one corner of a lower side from four corners of the rectangular projection area R to be registered. Then, the user presses the operation section 43 of the speaker 40 under that status (once pressed, pressing status is kept).

With reference to FIG. 4, the control section 11 of the information processing apparatus 10 first determines whether or not the operation section 43 of the speaker 40 is pressed (Step 101).

For example, as shown in the upper diagram of FIG. 5, in a case where the user presses the operation section 43 of the speaker 40, information showing the press is transmitted from the speaker 40 to the information processing apparatus 10. When the control section 11 of the information processing apparatus 10 receives the information showing the press of the operation section 43 (YES in Step 101), the control section 11 makes the plurality of cameras 30 to capture images and acquires the respective images from the plurality of cameras 30 (Step 102).

Next, the control section 11 of the information processing apparatus 10 extracts the plurality of images that show the markers 47 of the speakers 40, each of which the operation section 43 is pressed, from all images acquired (Step 103).

Next, the control section 11 of the information processing apparatus 10 calculates a coordinate of the speaker 40 in a space (XYZ coordinate system) on the basis of the position of the marker 47 at a plurality of viewpoints in the extracted plurality of images (Step 104).

Note that the coordinate to be calculated in Step 104 corresponds to one coordinate of the lower side in the rectangular projection area R in this embodiment. Hereinafter, the one coordinate of the lower side in the rectangular projection area R is referred to as a first coordinate P1 (see middle of FIG. 5).

With reference to a middle diagram of FIG. 5, while the user holds the speaker 40 and keeps pressing the operation section 43, the user moves. Then, the user positions the speaker 40 at the position corresponding to the other corner of the lower side from the four corners of the rectangular projection area R to be registered. Thereafter, the user releases the press in the operation section 43 of the speaker 40 under that status.

With reference to FIG. 4, after the coordinate (first coordinate P1) of the speaker 40 in the space is calculated, the control section 11 of the information processing apparatus 10 determines whether or not the press in the operation section 43 of the speaker 40 is released (Step 105).

For example, as shown in the middle drawing of FIG. 5, in a case where the user releases the press in the operation section 43 of the speaker 40, information showing the release of the press is transmitted from the speaker 40 to the information processing apparatus 10. When the control section 11 of the information processing apparatus 10 receives the information showing the release of the press in the operation section 43 (YES in Step 105), the control section 11 makes the plurality of cameras 30 to capture images and acquires the respective images from the plurality of cameras 30 (Step 106).

Next, the control section 11 of the information processing apparatus 10 extracts the plurality of images that shows the markers 47 of the speakers 40, each of which the press is released, from all images acquired (Step 107).

Next, the control section 11 of the information processing apparatus 10 calculates a coordinate of the speaker 40 in the space (XYZ coordinate system) on the basis of the position of the marker 47 at the plurality of viewpoints in the extracted plurality of images (Step 108).

Note that the coordinate to be calculated in Step 108 corresponds to the other coordinate of the lower side in the rectangular projection area R in this embodiment. Hereinafter, the other coordinate of the lower side in the rectangular projection area R is referred to as a second coordinate P2.

Next, the information processing apparatus 10 calculates coordinates (XYZ coordinate system) of the four corners of the projection area R on the basis of the first coordinate P1 and the second coordinate P2 (Step 109). Here, in this embodiment, an aspect ratio in the projection area R is determined in advance.

Accordingly, if two coordinates (i.e., first coordinate P1 and second coordinate P2) out of the coordinates of the four corners of the projection area R are determined, the coordinates of other two corners are automatically determined. In the following description, out of the coordinates at two corners of the upper side, a coordinate at one corner is referred to as a third coordinate P3 and a coordinate at the other corner is referred to as a fourth coordinate P4.

Note that the first coordinate P1 and the second coordinate P2 (coordinates at two corners of the lower side) specified by the user may have deviated values in the height direction (Z values). In this case, the projection area R may be inclined. Accordingly, the coordinates may be corrected so as to have the same values in the height direction of the first coordinate P1 and the second coordinate P2 (in this case, the values in the height direction of the third coordinate P3 and the fourth coordinate P4 will be the same).

Furthermore, when the operation section 43 of the speaker 40 is operated and the first coordinate P1 and the second coordinate P2 are registered, the speaker 40 is actually positioned a little distant from the wall. Accordingly, if any measure is not taken, the projection area R is undesirably registered at the position a little distant from the wall. Accordingly, the coordinates may be corrected such that the coordinates of the four corners are matched with the position of the wall (projection target).

In the same manner, the user holds the speaker 40 and the other projection area R is registered. Note that the user may register the respective projection areas R one by one by using one speaker 40 or may register a plurality of, or all projection areas R by using one (same) speaker 40. Thereafter, as shown in a lower diagram of FIG. 5, the user places the speaker 40 at any position in the room.

Note that, in this embodiment, it does not mean that the projection areas R are linked to the speaker 40 used for registering the projection areas R. In addition, in this embodiment, as it is possible to register all the projection areas R by using one (same) speaker 40, the operation section 43 may be arranged at at least one speaker 40 of the plurality of speakers 40.

It describes here the case that the first coordinate P1 is calculated when the operation section 43 of the speaker 40 is pressed and the second coordinate P2 is calculated when the press of the operation section 43 is released. On the other hand, when the operation section 43 of the speaker 40 is pressed and the press is immediately released (first time), the first coordinate P1 may be calculated. Next, when the operation section 43 of the speaker 40 is pressed and the press is immediately released (second time), the second coordinate P2 may be calculated.

In addition, it describes here the case that the two corners of the lower side in the projection area R are specified by the user. Two corners of a right side or two corners of a left side in the projection area R may be specified by the user. Alternatively, two corners diagonally positioned may be specified by the user. Furthermore, three corners, or all the four corners may be specified by the user.

In addition, it describes here the case that any projection area R is registered by the user using the speaker 40. On the other hand, any projection area R may be registered not by using the speaker 40 but by a gesture of the user and an audio command. In this case, a microphone for acquiring voice of the user is arranged on, for example, the speaker 40, the camera 30, or the like.

As an example, it assumes that the user makes a gesture of pointing a lower left (first coordinate P1) and an upper right (third coordinate P3) in the rectangular projection area R to be registered and says “here is lower left”, “here is upper right”, or the like.

In this case, the control section 11 of the information processing apparatus 10 first determines the coordinate of the position pointed by the user in the space (XYZ coordinate system) on the basis of the images acquired by the plurality of cameras 30. Then, the control section 11 of the information processing apparatus 10 analyzes the voice acquired by the microphone to determine that the coordinate of the position pointed by the user corresponds to which coordinate at the corner out of the four corners.

The control section 11 of the information processing apparatus 10 may recommend the projection area R for the user by an automatic recommendation function. In this case, for example, the control section 11 of the information processing apparatus 10 determines a color, flatness, and the like of the projection target such as the wall on the basis of the image acquired by the camera 30. Then, the control section 11 of the information processing apparatus 10 automatically calculates the area that can be projection area R in the room.

Then, the control section 11 of the information processing apparatus 10 projects the image on the area in advance and recommends the projection area R to the user. In this case, the user selects the projection area R to be registered from the recommended projection areas R.

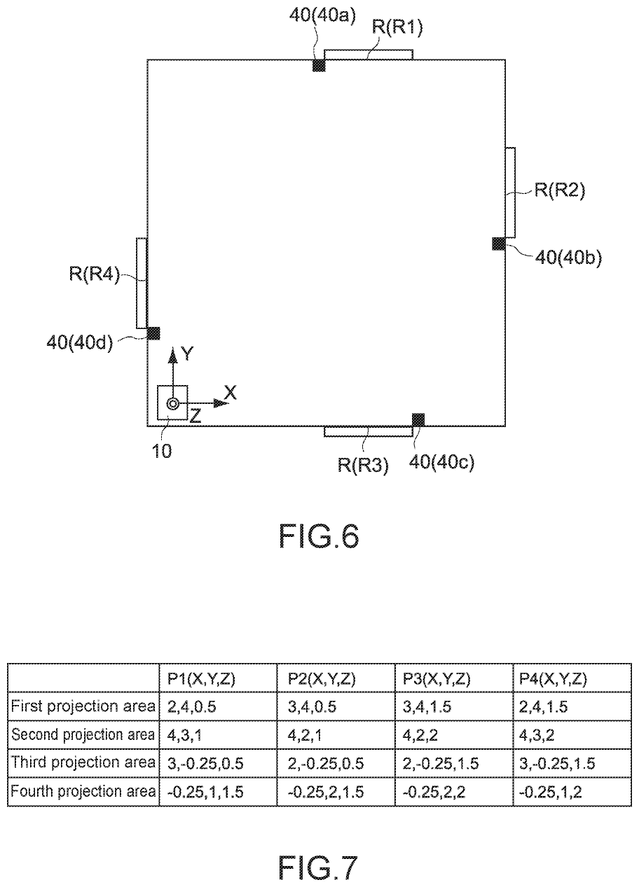

FIG. 6 shows an example of the positions of the plurality of projection areas R registered in the room. Note that FIG. 6 also shows the position of the information processing apparatus 10 and the positions of the speakers 40. FIG. 7 shows an example of the coordinates of the plurality of projection areas R.

As shown in FIG. 6, the control section 11 of the information processing apparatus 10 includes the XYZ coordinate system having the position of the information processing apparatus 10 as an origin. Note that the position of the origin of the XYZ coordinate system is not limited to the position of the information processing apparatus 10 and can be changed, as appropriate.

FIG. 6 and FIG. 7 show an example of the case that four projection areas R of the first projection area R1, the second projection area R2, a third projection area R3, and a fourth projection area R4 are registered as the projection areas R.

As described above, the respective projection areas R are defined by the coordinates of the four corners (first coordinate P1, second coordinate P2, third coordinate P3, and fourth coordinate P4).

In the example shown in FIG. 6 and FIG. 7, the first coordinate P1 (x, y, z), the second coordinate P2 (x, y, z), the third coordinate P3 (x, y, z), and the fourth coordinate P4 (x, y, z) of the first projection area R1 are (2, 4, 0.5), (3, 4, 0.5), (3, 4, 1.5), and (2, 4, 1.5), respectively.

Furthermore, the first coordinate P1 (x, y, z), the second coordinate P2 (x, y, z), the third coordinate P3 (x, y, z), and the fourth coordinate P4 (x, y, z) of the second projection area R2 are (4, 3, 1), (4, 2, 1), (4, 2, 2), and (4, 3, 2), respectively.

Furthermore, the first coordinate P1 (x, y, z), the second coordinate P2 (x, y, z), the third coordinate P3 (x, y, z), and the fourth coordinate P4 (x, y, z) of the third projection area R3 are (3, −0.25, 0.5), (2, −0.25, 0.5), (2, −0.25, 1.5), and (3, −0.25, 1.5), respectively.

Furthermore, the first coordinate P1 (x, y, z), the second coordinate P2 (x, y, z), the third coordinate P3 (x, y, z), and the fourth coordinate P4 (x, y, z) of the fourth projection area R4 are (−0.25, 1, 1.5), (−0.25, 2, 1.5), (−0.25, 2, 2), and (−0.25, 1, 2), respectively.

[Selection Processing of Speaker 40]

Next, it describes that processing of selecting an appropriate speaker 40 from the plurality of speakers 40 by the control section 11 of the information processing apparatus 10 for the projection area R specified by the user.

FIG. 9 is a flowchart showing the processing of selecting the speaker 40. First, the control section 11 of the information processing apparatus 10 determines whether or not any projection area R is specified by the user from the plurality of projection areas R (Step 201). There are a variety of methods of specifying the projection area R, e.g., specifying by a user's gesture, specifying by the voice, directly inputting to the information processing apparatus 10, etc. Any method may be used.

When the projection area R is specified, the control section 11 of the information processing apparatus 10 makes the respective plurality of cameras 30 to capture images and acquires the respective images from the plurality of cameras 30 (Step 202). Next, the control section 11 of the information processing apparatus 10 calculates the coordinate of each speaker 40 in the space (XYZ coordinate system) on the basis of the position of each marker 47 at the plurality of viewpoints in the plurality of images (Step 203).

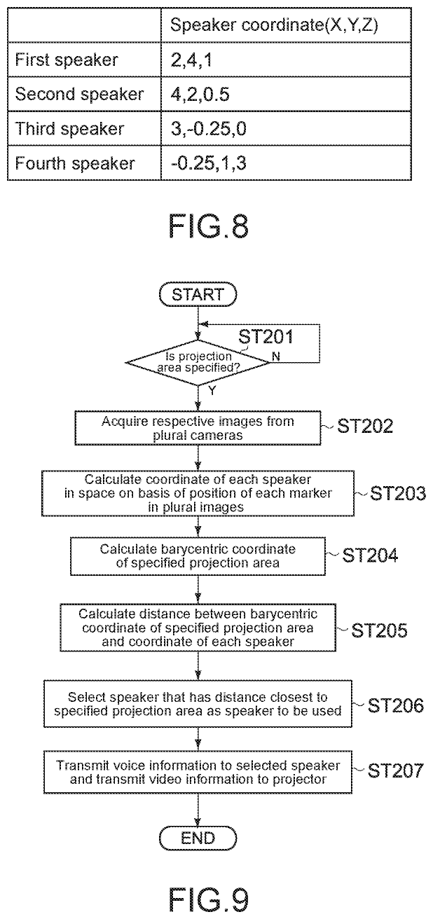

FIG. 8 shows an example of the coordinate of each speaker 40. With reference to FIG. 6 and FIG. 8, this example shows an example case that four speakers 40, i.e., a first speaker 40a, a speaker 40b, a third speaker 40c, and a fourth speaker 40d are arranged in the room.

In the example shown in FIG. 6 and FIG. 8, the coordinate (x, y, z) of the first speaker 40a, the coordinate (x, y, z) of the second speaker 40b, the coordinate (x, y, z) of the third speaker 40c, and the coordinate (x, y, z) of the fourth speaker 40d are (2, 4, 1), (4, 2, 0.5), (3, −0.25, 0), and (−0.25, 1, 3), respectively.

After the coordinate of each speaker 40 is calculated, the control section 11 of the information processing apparatus 10 next calculates a barycentric coordinate of the specified projection area R (Step 204). Then, the control section 11 of the information processing apparatus 10 calculates a distance between the barycentric coordinate of the specified projection area R and the coordinate of each speaker 40 (Step 205).

Here, it is said that due to human ears' characteristics, a resolution of a position of a sound source in the vertical direction (z axis direction) (power of identifying how high sound source is) is lower than a resolution of a position of the sound source in the horizontal direction (xy axis direction) (power of identifying position of sound source in horizontal direction).

Accordingly, when the distance between the specified projection area R and each speaker 40 is calculated, the control section 11 of the information processing apparatus 10 may calculate the distance by weighting so as to regard the distance in the horizontal direction (xy axis direction) as more important than the distance in the vertical direction (z axis direction).

By ignoring the distance in the vertical direction, only the distance in the horizontal direction can be referred (if weighting in the vertical direction is zero). Note that the calculation of the distance by weighting is similarly applicable to the case that the distance between the projection area R and the speaker 40 is calculated as described later (for example, Steps 310, 403, etc. as described later).

After the distance between the barycentric coordinate of the specified projection area R and the coordinate of each speaker 40 is calculated, the control section 11 selects the speaker 40 that has the distance closest to the specified projection area R as the speaker 40 to be used (Step 206).

For example, in the example shown in FIG. 6 to FIG. 8, in a case where the first projection area R1 is specified by the user, the first speaker 40a that has the distance closest to the first projection area R1 is selected as the speaker 40 used in the projection area R is selected.

Similarly, in a case where the second, the third, and the fourth projection areas R4 are specified by the user, the second, the third, and the fourth speakers 40d that have the distance closest to the second, the third, and the fourth projection areas R4 are selected as the speakers 40 used in the projection areas R are selected.

After the speaker 40 to be used is selected, the control section 11 of the information processing apparatus 10 transmits voice information to the selected speaker 40 and also transmits video information to the projector 20 (Step 207).

The control section 41 of the speaker 40 makes the voice based on the voice information received from the information processing apparatus 10 to be outputted.

Furthermore, the control section 21 of the projector 20 adjusts the direction and the posture of the projector 20 by the posture control mechanism so as to be capable of projecting a video on the selected projection area R and then projects the video based on the video information received from the information processing apparatus 10 on the projection area R.

The control section 21 of the projector 20 (or the control section 11 of the information processing apparatus 10) may perform a geometric correction on the video if the projection area R has unevenness or may perform a color tone correction on the video to be projected depending on a color tone of the projection area R.

### <Actions, Etc.>

(Selection of Speaker 40)

The information processing apparatus 10 according to this embodiment acquires information about the position (coordinate) of the specified projection area R from the plurality of projection areas R capable of projecting videos and acquires information about the positions (coordinates) of the plurality of speakers 40 capable of outputting the voice. Then, on the basis of the information about the position (coordinate) of the specified projection area R and the information about the positions (coordinates) of the plurality of speakers 40, the speaker 40 to be used in the projection area R is selected.

Thus, corresponding to the position of the specified projection area, the appropriate speaker 40 can be selected from the plurality of speakers 40. Accordingly, in this embodiment, video experience that the position of the projection area R and the position of the sound source are not deviated can be provided, to thereby preventing a realistic feeling of the user who views the video and hears the voice from being damaged.

Furthermore, in this embodiment, since the speaker 40 to be used is selected on the basis of the distance between the specified projection area R and each speaker 40, the appropriate speaker 40 can be more effectively selected from the plurality of speakers 40.

Furthermore, in this embodiment, since the speaker 40 that has the distance closest to the specified projection area R as the speaker 40 to be used from the plurality of speakers 40 is selected, the appropriate speaker 40 can be more effectively selected from the plurality of speakers 40.

Furthermore, in this embodiment, in the selection of the speaker 40, when the respective positions of the plurality of speakers 40 are acquired, the markers 47 arranged at the respective speakers 40 are used. Thus, the respective positions of the plurality of speakers 40 can be accurately determined.

Here, in this embodiment, the speaker 40 is allowed to have the size and the weight to the extent that the user can hold by one hand. Accordingly, the position of the speaker 40 in the room may be often changed by the user. For example, the user may change the position of the speaker 40 because the position of the speaker 40 is changed to a more desirable position, the speaker 40 is in the way of cleaning, etc.

Therefore, in this embodiment, every time the user specifies the projection area R, current positions of the plurality of speakers 40 are acquired and the current positions of the speakers 40 are allowed to be used for calculating the distance to the specified projection area R (see Step 201 to Step 205). Thus, every time the user specifies the projection area R, the current positions of the plurality of speakers 40 are acquired, which can be appropriately corresponded to the case that the positions of the speakers 40 are often changed.

(Register of Projection Area R)

In this embodiment, the information about the position (coordinates P1, P2, etc.) of the speaker 40 held by the user is acquired and the projection area R is registered on the basis of the information about the speaker 40. Thus, the user holds the speaker 40, moves the speaker 40, and can intuitively register the projection area R in the space.

Furthermore, in this embodiment, when the position of the speaker 40 is acquired in the register of the projection area R, the marker 47 arranged at the speaker 40 is used. Thus, the position of the speaker 40 can be accurately determined.

Furthermore, in this embodiment, the operation section 43 is arranged at the speaker 40 in order to register the projection area R, the position of the speaker 40 (position of marker 47) is acquired at the timing that the operation section 43 is operated. Thus, by operating the operation section 43, the user can easily register the projection area R in any area in the space.

Furthermore, in this embodiment, there is also a usage that the speaker 40 is allowed to be arranged near the registered projection area R (see FIG. 6). In this case, it can prevent the user from forgetting where the projection area R is arranged.

### Modification of First Embodiment

The above describes the case that every time the user specifies the projection area R, the current positions of the plurality of speakers 40 are acquired and the current positions of the speakers 40 are used for calculating the distance to the specified projection area R. On the other hand, the positions of the plurality of speakers 40 may be registered in advance.

As an example, after the user arranges the speaker 40 at any position in the room (for example, see lower side of FIG. 5), the user presses the operation section 43 arranged at the speaker 40 (once presses, immediately releases: this operation is different from the operation for registering the projection area R).

When the control section 11 of the information processing apparatus 10 receives information showing that the operation section 43 is pressed (pressed and immediately released) from the speaker 40, the position of the speaker 40 (speaker 40 in which operation section 43 is operated) on the basis of the plurality of images acquired by the cameras 30.

In this manner, the control section 11 of the information processing apparatus 10 registers the positions of all speakers 40 in advance. Note that after the user arranges all speakers 40 at any positions, the user may press the operation section 43 (the same is applied when places where the speakers 40 are arranged are changed).

In this case, the control section 11 of the information processing apparatus 10 can recognize the positions of all projection areas R and the positions of all speakers 40 in advance. Accordingly, in this case, the control section 11 of the information processing apparatus 10 determines which is the speaker 40 that has the distance closest to the specified projection area R for all projection areas R in advance, and makes the storage section 12 to store each relationship between the projection area R and the speaker 40.

Then, when the projection area R used in that time is specified, the control section 11 of the information processing apparatus 10 may select the speaker 40 correlated with the projection area R as the speaker 40 to be used.

The above describes the case that once the position of the projection area R is registered, the position of the projection area R is fixed. On the other hand, a situation of the projection target to which the projection area R is set may be changed and if the position of the projection area R is fixed, there is a possibility not to correspond to a change in the situation of the projection target.

The change in the situation of the projection target (wall, etc.) refers to the case that sun's light strikes the projection target, an object is placed on (leaned against) the projection target, or the like, for example.

Accordingly, the control section 11 of the information processing apparatus 10 may determine the situation of the projection target to which the projection area R is set (on basis of images, etc. of cameras 30) and may change at least one of the position and the size of the projection area R on the basis of the situation of the determined projection target. For example, in a case where sun's light strikes the projection target or an object is placed on the projection target, the control section 11 of the information processing apparatus 10 allows to change at least one of the position and the size of the projection area R so as to avoid the sun's light or the object.

In a case where the position of the projection area R is made to be changed, the control section 11 of the information processing apparatus 10 calculate a distance between the position of the projection area R after the change and the position of each speaker 40, and determines the speaker 40 that has the distance closest to the projection area R. Then, the control section 11 of the information processing apparatus 10 may select the speaker 40 as the speaker 40 to be used. Here, when the speaker is selected, the situation that the speaker 40 is selected may be notified to the user by illuminating around the speaker 40 by the projector 20 or the selection situation may be presented by the voice from the speaker 40.

### Second Embodiment

Next, a second embodiment of the present technology will be described. In the description after the second embodiment, parts including structure and functions similar to the above-described first embodiment are denoted by the same reference numerals, and thus detailed description thereof will be omitted.

The above first embodiment describes the case that one speaker 40 is selected as the speaker 40 to be used for the specified projection area R. On the other hand, the second embodiment is different from the first embodiment in that two or more speakers 40 to which respective different voice channels are allocated as the speaker 40 to be used for the specified projection area R. Accordingly, this point will be mainly described.

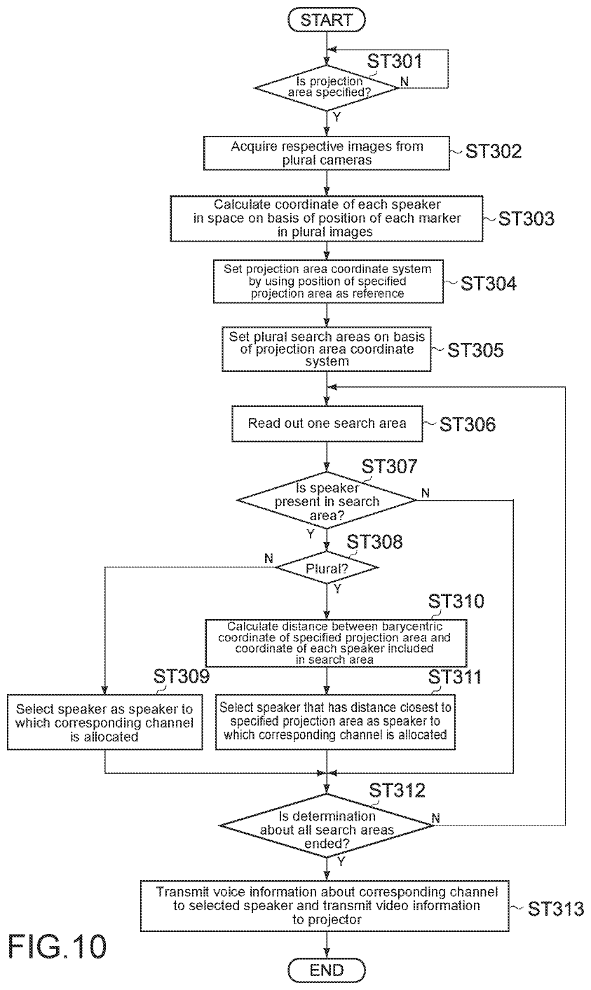

FIG. 10 is a flowchart showing the processing of selecting the speaker 40 in the second embodiment.

As shown in FIG. 10, the control section 11 of the information processing apparatus 10 first determines whether or not any projection area R is specified by the user from the plurality of projection areas R (Step 301). When the projection area R is specified (YES in Step 301), the control section 11 of the information processing apparatus 10 makes the respective plurality of cameras 30 to capture images and acquires the respective images from the plurality of cameras 30 (Step 302).

Next, the control section 11 of the information processing apparatus 10 calculates the coordinate of each speaker 40 in the space (XYZ coordinate system) on the basis of the position of each marker 47 at the plurality of viewpoints in the plurality of images (Step 303).

Next, the control section 11 of the information processing apparatus 10 sets a projection area coordinate system by using the position of the specified projection area R (barycentric coordinate) as a reference (origin) (Step 304). Next, the control section 11 of the information processing apparatus 10 sets a plurality of search areas on the basis of the projection area coordinate system (Step 305).

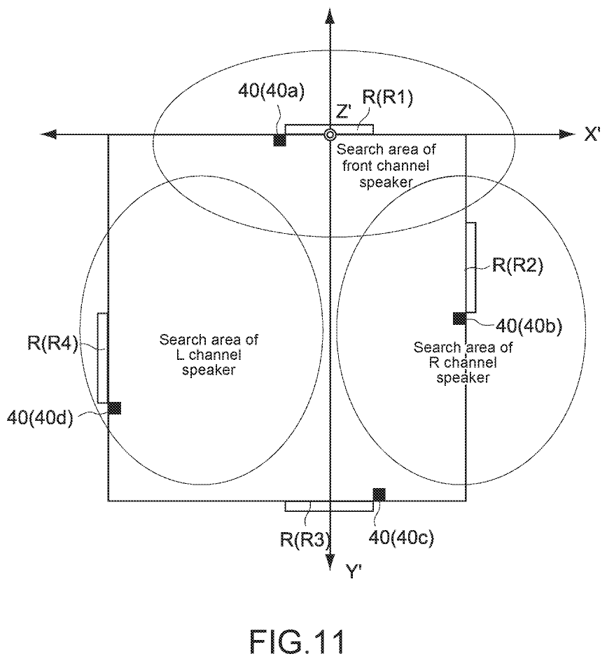

FIG. 11 shows the plurality of search areas set on the basis of the projection area coordinate system. FIG. 11 shows a state that the first projection area R1 is specified by the user from the four projection areas R and the projection area coordinate system is set by using the position of the first projection area R1 (barycentric coordinate) as a reference (origin).

In the projection area coordinate system, a line passing through the barycentric coordinate of the projection area R and drawn vertically to the face of the projection area R is taken as the Y′ axis. In addition, a line passing through the barycentric coordinate of the projection area R and drawn in parallel with the horizontal direction in the projection area R is taken as the X′ axis. In addition, a line passing through the barycentric coordinate of the projection area R and drawn in parallel with the vertical direction in the projection area R is taken as the Z′ axis.

In the example shown in FIG. 11, three search areas are set as the plurality of search areas. The first search area of the three search areas is a search area of a front channel speaker for searching the speaker 40 to which a Front channel is allocated.

The second search area is a search area of an R channel speaker for searching the speaker 40 to which an R (Right) channel is allocated. In addition, the third search area is a search area of an R channel speaker for searching the speaker 40 to which an L (Left) channel is allocated.

The search area of the front channel speaker is set in a range closer to the specified projection area R so as to surround the projection area R. In addition, the search area of the R channel speaker is set in a range a little distant from the projection area R and at a right side of the Y axis (right side viewed from a user side: left side viewed from projection area R side) at a front side of the projection area R.

In addition, the search area of the L channel speaker is set in a range a little distant from the projection area R and at a left side of the Y axis (left side viewed from a user side: right side viewed from projection area R side) at the front side of the projection area R.

In the example shown in FIG. 11, the number of search areas is three corresponding to the Front channel, the R channel, and the L channel. On the other hand, if the number of the channels is two, the number of the search areas may be two. If the number of the channels is four, the number of the search areas may be four. That is to say, if the number of the channels to be allocated is changed, the number of search areas may be changed corresponding thereto.

The control section 11 of the information processing apparatus 10 sets the plurality of search areas and then reads out one search area from the storage section 12 (Step 306). Next, the control section 11 determines whether or not the speaker 40 is present in the search area on the basis of the coordinate of each speaker 40 (Step 307).

In a case where the speaker 40 is present in the search area (YES in Step 307), the control section 11 of the information processing apparatus 10 determines whether or not the number of the speaker(s) 40 present in the search area is plural (Step 308).

In a case where the number of the speaker 40 present in the search area is one (NO in Step 308), the control section 11 of the information processing apparatus 10 selects the speaker 40 as the speaker 40 to which a corresponding channel is allocated (Step 309). Then, the control section 11 of the information processing apparatus 10 proceeds to next Step 312.

On the other hand, in a case where the plurality of speakers 40 is present in the search area (YES in Step 308), the control section 11 of the information processing apparatus 10 calculates a distance between the barycentric coordinate of the specified projection area R and the coordinate of each speaker 40 present in the search area (Step 310).

Next, the control section 11 selects the speaker 40 that has the distance closest to the specified projection area R as the speaker 40 to which the corresponding channel is allocated (Step 311). Then, the control section 11 proceeds to next Step 312.

Note that in a case where the plurality of speakers 40 is present in one search area, the speakers 40 may be selected with a good balance taking an arrangement balance of the respective speakers 40 into consideration. In this case, for example, the arrangement balance of the speakers 40 is considered by using a straight line joining the specified projection area R and the position of the user (determinable by image as described later) as a reference. In addition, in a case where the plurality of speakers 40 is present in one search area, information about an audible area described later may be used.

In Step 307, in a case where the speaker 40 is not present in the read-out search area (NO in Step 307), the control section 11 of the information processing apparatus 10 does not select the speaker 40 to which the corresponding channel is allocated and proceeds to Step 312.

In Step 312, the control section 11 of the information processing apparatus 10 determines whether or not the processing regarding to the selection of the speaker 40 for all search areas is ended (processing in Step 307 to Step 311). If the area in which the processing regarding to the selection of the speaker 40 is not ended still remains (NO in Step 312), the control section 11 of the information processing apparatus 10 reads out one next area (Step 306) and executes the processing after Step 307.

If the processing regarding to the selection of the speaker 40 is ended for all areas (YES in Step 312), the control section 11 of the information processing apparatus 10 proceeds to next Step 313. In Step 313, the control section 11 of the information processing apparatus 10 transmits the video information to the projector 20 and also transmits a voice signal of the corresponding channel to the selected speaker 40.

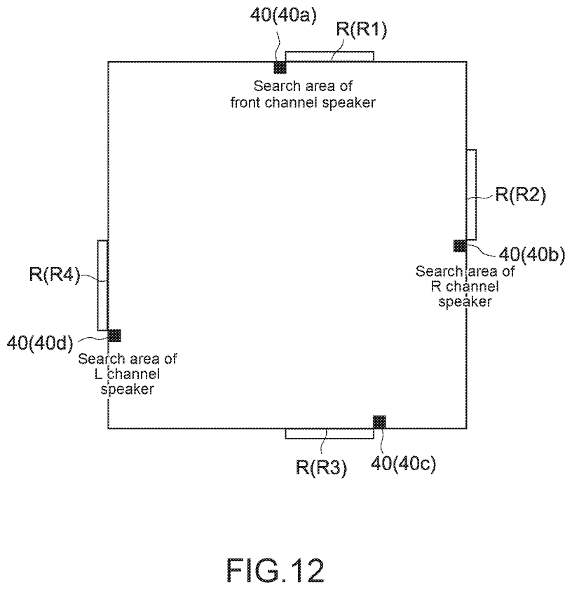

FIG. 12 shows a state that the voice channel is allocated to any speaker 40.

In FIG. 11, since only the first speaker 40a is present in the search area of the front channel speaker, as shown in FIG. 12, the first speaker 40a is selected as the front channel speaker 40 to which the front channel is allocated.

In addition, in FIG. 11, since only the second speaker 40b is present in the search area of the R channel speaker, as shown in FIG. 12, the second speaker 40b is selected as the speaker 40 to which the R channel is allocated.

Similarly, in FIG. 11, since only the fourth speaker 40d is present in the search area of the L channel speaker, as shown in FIG. 12, the fourth speaker 40d is selected as the R channel speaker 40 to which the L channel is allocated.

In the second embodiment, two or more speakers 40 are selected as the speaker 40 to be used and the different voice channels are allocated to the two or more speakers 40. Accordingly, if there is the plurality of voice channels, it is possible to be appropriately corresponded.

Furthermore, in the second embodiment, the plurality of search areas is set and the speaker 40 is selected used for each search area. Thus, the speaker 40 to which the channel is to be allocated can be appropriately selected in each search area.

Furthermore, in the second embodiment, each of the plurality of search areas is set using the position of the specified projection area R (projection area coordinate system) as a reference. Thus, each of the plurality of areas for searching the speaker 40 to which the channel is to be allocated can be appropriately set.

Note that this example describes the case that if the speaker 40 is not present in the search area concerned, the corresponding channel is not allocated to the speaker 40. For example, it assumes that the speakers 40 are present at the search area of the front channel speaker and the search area of the R channel speaker, but the speaker 40 is not present at the search area of the L channel speaker. In such a case, in the example shown in FIG. 10, the front channel speaker and the R channel speaker 40 are selected, but the L channel speaker 40 is not selected.

On the other hand, if the speaker 40 is thus not present at at least one area out of all areas and the speaker 40 is not capable of being selected, outputs of the plurality of voice channels may be changed to outputs of a monaural channel voice. In this case, one speaker 40 that outputs the monaural channel voice (for example, speaker 40 that has distance closest to projection area R) (see first embodiment).

### Third Embodiment

Next, a third embodiment of the present technology will be described. The third embodiment and later are different from the above-described respective embodiments in that not only the information about the position of the specified projection area R and the information about the position of the speaker 40, but also the information about the position of the user are used as the information for selecting the speaker 40 to be used.

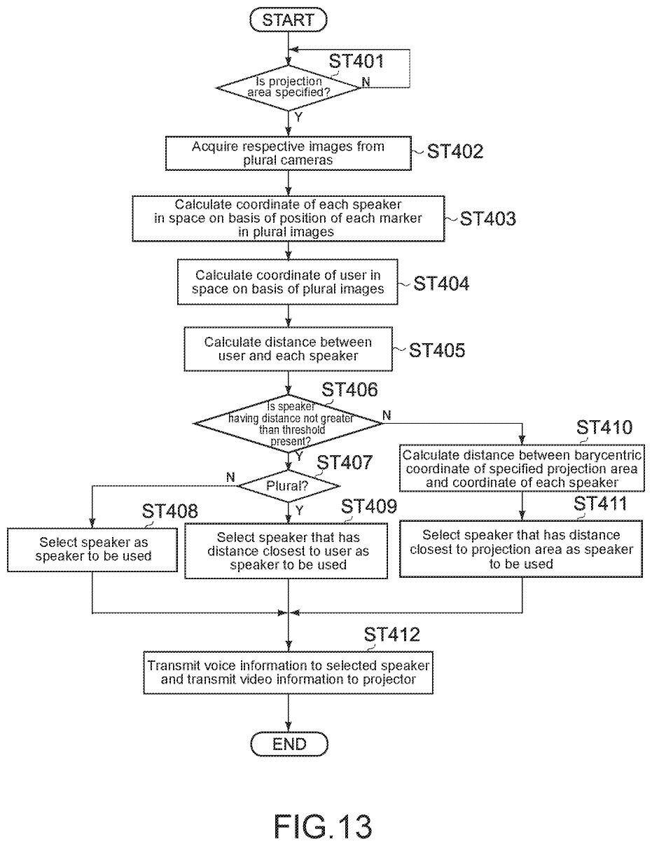

FIG. 13 is a flowchart showing the processing of selecting the speaker 40 in the third embodiment.

As shown in FIG. 13, the control section 11 of the information processing apparatus 10 first determines whether or not any projection area R is specified by the user from the plurality of projection areas R (Step 401). When the projection area R is specified (YES in Step 401), the control section 11 of the information processing apparatus 10 makes the respective plurality of cameras 30 to capture images and acquires the respective images from the plurality of cameras 30 (Step 402).

Next, the control section 11 of the information processing apparatus 10 calculates the coordinate of each speaker 40 in the space (XYZ coordinate system) on the basis of the position of each marker 47 at the plurality of viewpoints in the plurality of images (Step 403).

Next, the control section 11 of the information processing apparatus 10 calculates the coordinate of the user in the space (XYZ coordinate system) on the basis of the position of the user at the plurality of viewpoints in the plurality of images (Step 404).

After the coordinate of the user is calculated, the control section 11 of the information processing apparatus 10 next calculates the distance between the user and each speaker 40.

Note that when the distance between the user and each speaker 40 is calculated, the control section 11 of the information processing apparatus 10 may calculate the distance by weighting so as to regard the distance in the horizontal direction (xy axis direction) as more important than the distance in the vertical direction (z axis direction).

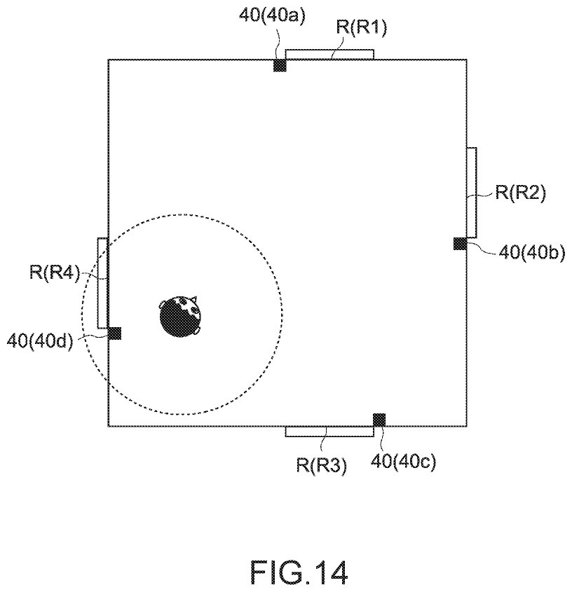

Next, the control section 11 of the information processing apparatus 10 determines whether or not the speaker 40 having the distance to the user not greater than a threshold (Step 406). FIG. 14 shows the distance (threshold) from the user.

In a case where the speaker 40 having the distance to the user not greater than the threshold is present (YES in Step 406), the control section 11 of the information processing apparatus 10 determines whether or not the number of the speaker(s) 40 is plural (Step 407).

In a case where the number of the speaker 40 having the distance to the user not greater than the threshold is one (NO in Step 308), the control section 11 of the information processing apparatus 10 selects the one speaker 40 as the speaker 40 to be used (Step 408). Then, the control section 11 of the information processing apparatus 10 proceeds to next Step 412.

Note that, in the example shown in FIG. 14, since only the fourth speaker 40d having the distance to the user not greater than the threshold is present, the fourth speaker 40d is selected as the speaker 40 to be used.

On the other hand, in Step 407, in a case where the plurality of speakers 40 each having the distance to the user not greater than the threshold is present (YES in Step 407), the control section 11 of the information processing apparatus 10 selects the speaker 40 that has the distance closest to the user as the speaker 40 to be used (Step 409). Then, the control section 11 of the information processing apparatus 10 proceed to next Step 412.

In Step 406, in a case where the speaker 40 having the distance to the user not greater than the threshold is not present (NO in Step 407), the distance between the barycentric coordinate of the specified projection area R and the coordinate of each speaker 40 is calculated (Step 410).

Then, the control section 11 of the information processing apparatus 10 selects the speaker 40 that has the distance closest to the specified projection area R as the speaker 40 to be used (Step 411). Then, the control section 11 of the information processing apparatus 10 proceeds to next Step 412.

In Step 412, the control section 11 of the information processing apparatus 10 transmits video information to the projector 20 and also transmits the voice information to the selected speaker 40.

In third embodiment, the speaker 40 to be used is selected also on the basis of the information about the position of the user. Thus, corresponding to the position of the user, the appropriate speaker 40 can be selected from the plurality of speakers 40.

Furthermore, in the third embodiment, since the speaker 40 to be used is selected on the basis of the distance between the user and each speaker 40, the appropriate speaker 40 can be more effectively selected from the plurality of speakers 40.

### Fourth Embodiment

Next, a fourth embodiment of the present technology will be described. The fourth embodiment is different from the above-described respective embodiments in that not only the information about the position of the specified projection area R, the information about the position of the speaker 40, and the information about the position of the use, but also the information about the audible area of the speaker 40 is used as the information for selecting the speaker 40 to be used.

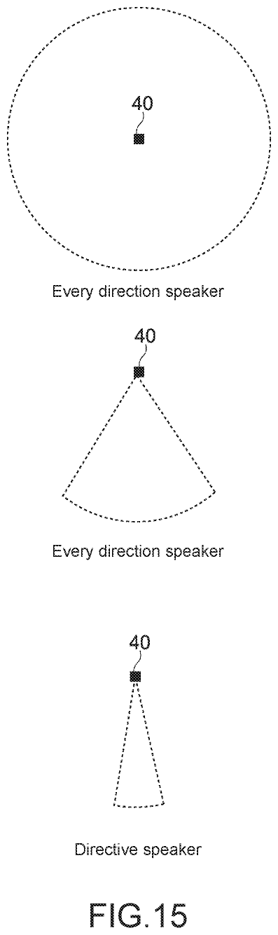

FIG. 15 shows an example of the audible area. Note that the audible area means an area at which sound from the speaker 40 effectively arrives.

As shown in FIG. 15, there are a various types of speakers 40 including, for example, an every direction speaker 40, a normal speaker 40, a directional speaker 40, and the like. Furthermore, respective shapes of the audible areas are different corresponding to the types of the speakers 40.

Since the every direction speaker 40 is capable of evenly outputting the sound in the every direction, the audible area of the every direction speaker 40 is, for example, a circle (viewed in upper or lower direction). In addition, since the normal speaker 40 outputs the sound with some extent of a directivity, the audible area of the normal speaker 40 has, for example, a central angle having a rather wide fan shape (viewed in upper or lower direction). In addition, since the directional speaker 40 outputs the sound with the directivity, the audible area of the directional speaker 40 has, for example, the central angle having a rather narrow fan shape (viewed in upper or lower direction).

In the fourth embodiment, information about the audible area shown in FIG. 15 is used as information for selecting the speaker 40 to be used.

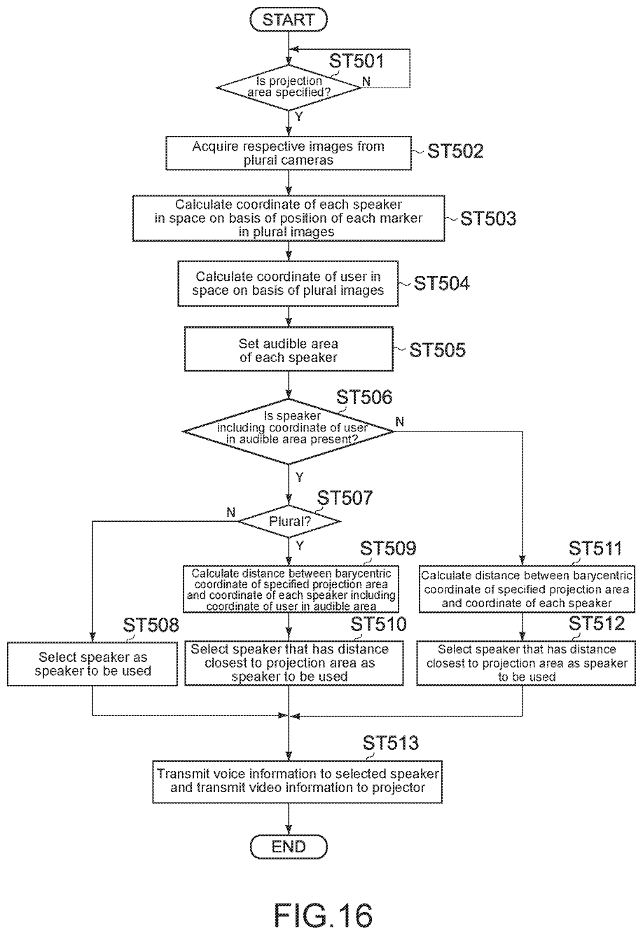

FIG. 16 is a flowchart showing the processing of selecting the speaker 40 in the fourth embodiment.

As shown in FIG. 16, the control section 11 of the information processing apparatus 10 first determines whether or not any projection area R is specified by the user from the plurality of projection areas R (Step 501). When the projection area R is specified (YES in Step 501), the control section 11 of the information processing apparatus 10 makes the respective plurality of cameras 30 to capture images and acquires the respective images from the plurality of cameras 30 (Step 502).

Next, the control section 11 of the information processing apparatus 10 calculates the coordinate of each speaker 40 in the space (XYZ coordinate system) on the basis of the position of each marker 47 at the plurality of viewpoints in the plurality of images (Step 503).

Next, the control section 11 of the information processing apparatus 10 calculates the coordinate of the user in the space (XYZ coordinate system) on the basis of the position of the user at the plurality of viewpoints in the plurality of images (Step 504).

Next, the control section 11 of the information processing apparatus 10 acquires information about the audible area of each speaker 40 and sets the audible area in the space (XYZ coordinate system). In order to set the audible area of each speaker 40, the control section 11 of the information processing apparatus 10 may acquire information about the types of respective speakers 40 (every direction speaker 40, normal speaker 40, and directional speaker 40). Note that once the type of the speaker 40 is specified, the shape of the audible area is specified.

For example, in a case where the specific speaker 40 is the every direction speaker 40 in terms of the type of the speaker 40, a circle audible area is set on the basis of the coordinate of the speaker 40. Furthermore, in a case where the specific speaker 40 is the normal speaker 40 or the directional speaker 40 in terms of the type of the speaker 40, a fan-shaped audible area is set on the basis of the coordinate of the speaker 40.

Here, in a case where the speaker 40 is the normal speaker 40 or the directive speaker 40 in terms of the type of the speaker 40, the control section 11 of the information processing apparatus 10 needs to determine the direction to which the speaker 40 directs. The direction to which the speaker 40 directs is determinable on the basis of the image acquired by the camera 30. Note that, as described above, since the marker 47 is arranged at the front face of the case 46 in the speaker 40 (see FIG. 3), it is possible to determine the direction to which the speaker 40 is directs on the basis of the position of the marker 47 with respect to the whole speaker 40.

Note that, in order to specify the audible area, the sound outputted from the speaker 40 may be actually measured. In this case, a plurality of microphones for collecting the sound from the speaker 40 may be arranged at respective places within the room, for example. In addition, if a hearing ability of the user is capable of being estimated from a user's age, etc., a size of the audible area may be adjusted corresponding to the hearing ability of the user. Alternatively, by referring to a set sound volume of other voice output device (e.g., television device, etc.), the hearing ability of the user is estimated and the audible area may be adjusted.

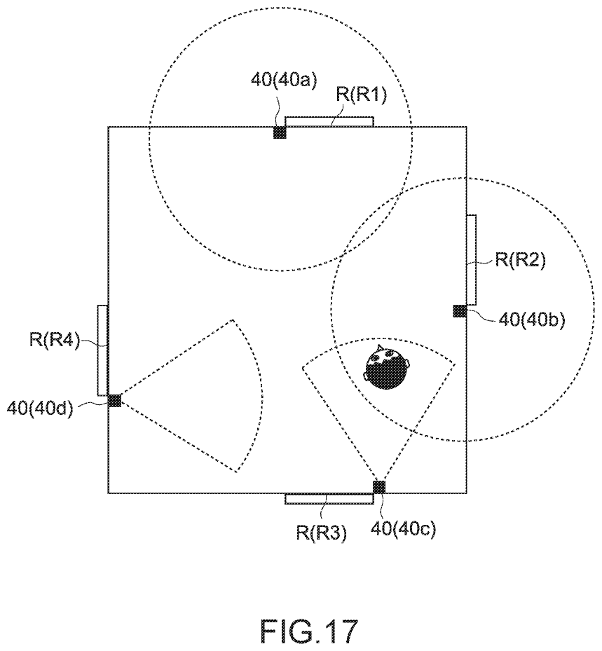

FIG. 17 shows a state that each audible area is set to each speaker 40.

FIG. 17 shows an example of the case that the first speaker 40a and the second speaker 40b are the every direction speakers 40 and the third speaker 40c and the fourth speaker 40d are the normal speakers 40. In addition, FIG. 17 also shows the position of the user (for example, position when any projection area R is specified by gesture). Note that, in FIG. 17, it assumes that the first projection area R1 is specified by the user.

After the audible area is set, the control section 11 of the information processing apparatus 10 next determines whether or not the speaker 40 including the coordinate of the user in the audible area is present (Step 506). In a case where the speaker 40 including the coordinate of the user in the audible area is present (YES in Step 506), the control section 11 of the information processing apparatus 10 determines whether or not the number of the speaker(s) 40 including the coordinate of the user in the audible area is plural (Step 507).

In a case where only one speaker 40 including the coordinate of the user in the audible area is present (NO in Step 507), the control section 11 of the information processing apparatus 10 selects the speaker 40 as the speaker 40 to be used (Step 508). Then, the control section 11 of the information processing apparatus 10 proceeds to next Step 513.

On the other hand, in a case where plural speakers 40 each including the coordinate of the user in the audible area are present (YES in Step 507), the control section 11 of the information processing apparatus 10 proceeds to next Step 509. In Step 509, the control section 11 of the information processing apparatus 10 calculates each distance between the barycentric coordinate of the specified projection area R and the coordinate of each speaker 40 including the coordinate of the user in the audible area.

Next, the control section 11 of the information processing apparatus 10 selects the speaker 40 that has the distance closest to the projection area R from the plural speakers 40 each including the coordinate of the user in the audible area as the speaker 40 to be used (Step 510). Then, the control section 11 of the information processing apparatus 10 proceeds to next Step 513.

Note that, in FIG. 17, as the speakers 40 each including the coordinate of the user in the audible area, two speakers 40, i.e., the second speaker 40b and the third speaker 40c, are present. In this case, the second speaker 40b that has the distance closest to the first projection area R specified by the user is selected from the second speaker 40b and the second speaker 40b as the speaker 40 to be used.

In Step 506, in a case where the speaker 40 having the distance to the user not greater than the threshold is not present (NO in Step 506), the control of the information processing apparatus 10 calculates a distance between the barycentric coordinate of the specified projection area R and the coordinate of each speaker 40 (Step 511).

Then, the control section 11 of the information processing apparatus 10 selects the speaker 40 that has the distance closest to the specified projection area R as the speaker 40 to be used (Step 512). Then, the control section 11 of the information processing apparatus 10 proceeds to next Step 513.

In Step 513, the control section 11 of the information processing apparatus 10 transmits the voice information to the selected speaker 40 and transmits the video information to the projector 20.

In the fourth embodiment, the speaker 40 to be used is selected on the basis of the information about the audible area of each speaker 40. Thus, corresponding to the audible area of the speaker 40, the appropriate speaker 40 can be selected from the plurality of speakers 40.

### Fifth Embodiment

Next, a fifth embodiment of the present technology will be described. The fifth embodiment is different from the above-described respective embodiments in that a user coordinate system based on the user is set in order to select the speaker 40 to be used in the fourth embodiment.

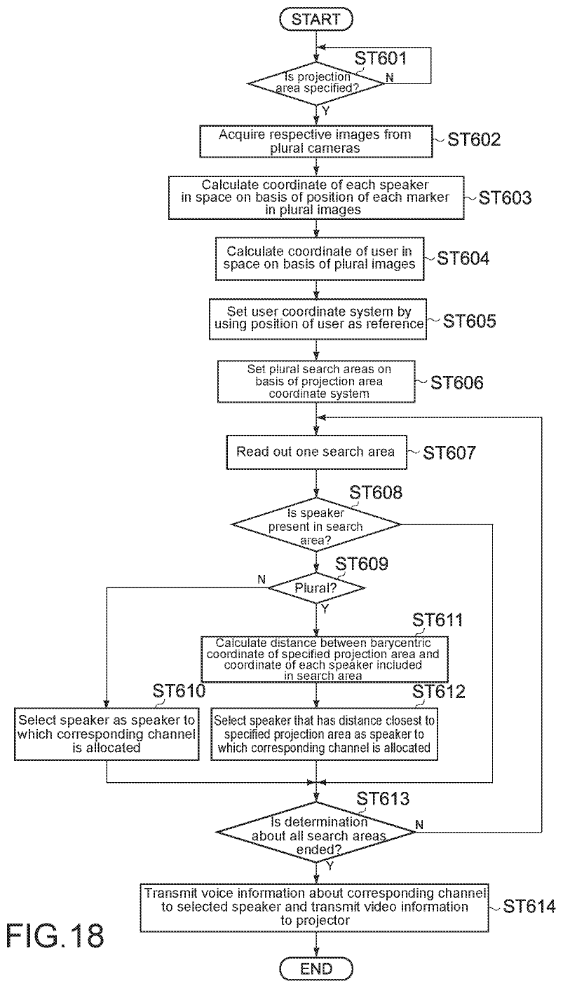

FIG. 18 is a flowchart showing the processing of selecting the speaker 40 in the fifth embodiment.

First, the control section 11 of the information processing apparatus 10 determines whether or not any projection area R is specified by the user from the plurality of projection areas R (Step 601). When the projection area R is specified (YES in Step 601), the control section 11 of the information processing apparatus 10 makes the respective plurality of cameras 30 to capture images and acquires the respective images from the plurality of cameras 30 (Step 602).

Next, the control section 11 of the information processing apparatus 10 calculates the coordinate of each speaker 40 in the space (XYZ coordinate system) on the basis of the position of each marker 47 at the plurality of viewpoints in the plurality of images (Step 603).

Next, the control section 11 of the information processing apparatus 10 calculates the coordinate of the user in the space (XYZ coordinate system) on the basis of the position of the user at the plurality of viewpoints in the plurality of images (Step 604). In addition, in this time, the direction to which the user directs, etc. is determined.

Next, the control section 11 of the information processing apparatus 10 sets the user coordinate system by using the position of the user as a reference (origin) (Step 605). Next, the control section 11 of the information processing apparatus 10 sets the plurality of search areas on the basis of the projection area coordinate system (Step 606).

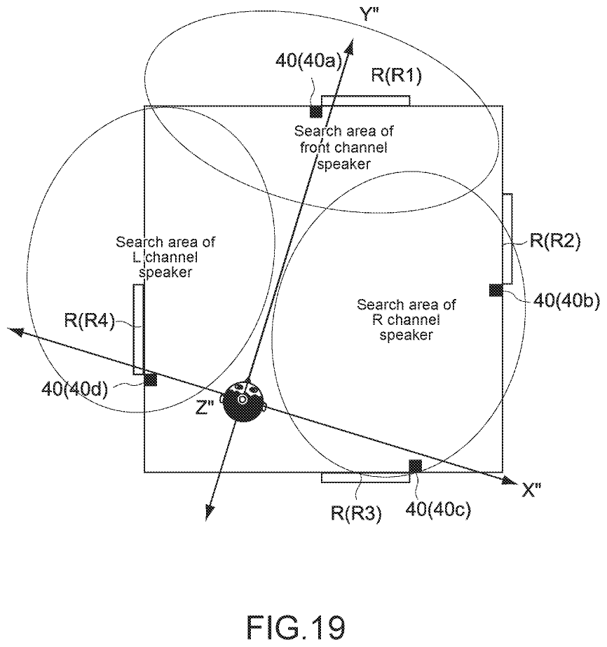

FIG. 19 shows the plurality of search areas set on the basis of the user coordinate system. FIG. 19 shows an example case that the first projection area R1 is specified by the user from the four projection areas R and the user directs to the direction of the first projection area R1.

In the user coordinate system, the coordinate of the user is set as an origin and a front and back direction of the user (determinable from direction of user's face, etc.) is taken as the Y″ axis. In addition, a left and right direction of the user is set to the X″ axis, and a direction orthogonal to the X″ axis and the Y″ axis is set to the Z″ axis.

In the example shown in FIG. 19, the search area of the front channel speaker is set in an area around the Y axis at a position a little distant from the user. In addition, the search area of the R channel speaker is set in a range near the user and a range at a right side of the Y axis (right side viewed from a user side). In addition, the search area of the L channel speaker is set in a range near the user and a range at a left side of the Y axis (left side viewed from projection area R side).

Note that since processing from Step 607 to Step 614 thereafter is similar to Step 306 to Step 313 in FIG. 10 (second embodiment) as described above, thus detailed description thereof will be omitted. Note that in the above-described second embodiment, the search area is set on the basis of a projection coordinate system. In contrast, in the fifth embodiment, the search area is set on the basis of the user coordinate system.

In the fifth embodiment, since the search area is set on the basis of the user the coordinate, even if the user is positioned at any position in the space (even if user directs in any direction), the appropriate speaker 40 to which the channel is to be allocated can be selected.

### Various Modifications

The above describes the case that the number of the projector 20 is one, but the number of the projector 20 may be plural. In addition, the above describes the case that the projector 20 is movable, but the projector 20 may be stationary (in particular, if number of projector 20 is plural). In addition, instead of the projector 20, a mounting type device capable of displaying the video at the position corresponding to the registered projection area may be used.

The above describes the case that the number of the camera is plural, but the number of the camera 30 may be one. An imaging wavelength is not limited to a visible light region and may include an ultraviolet region and an infrared region. In addition, instead of the camera 30, a sensor that measures only illuminance may be used.

In addition, in order to detect the position and a movement of the user, in addition to or instead of the camera 30, a depth sensor, a thermo-camera, a microphone, or the like may be used. In addition, in order to detect the position of the speaker 40, in addition to or instead of the camera 30, a depth sensor, a microphone, or the like may be used.

The above describes that the speaker 40 is portable but may be stationary (for example, large speaker 40). Instead of the dedicated speaker 40, a device having a sound output section such as a smartphone, a game machine, a mobile music player, and the like may be used.

The above describes the case that the information processing apparatus 10 is separate from the projector 20, the camera 30, the speaker 40, and the like. On the other hand, the information processing apparatus 10 may be integrated with the projector 20, the camera 30, or the speaker 40 (in this case, projector 20, camera 30, or speaker 40 takes a role of information processing apparatus 10).

The above-described respective embodiments can be combined each other. As an example, a combination of the second embodiment and the fifth embodiment will be described. In this case, a method of selecting the speaker 40 by using the projection coordinate system is combined with a method of selecting the speaker 40 by using the user coordinate system.

In this case, for example, the control section 11 of the information processing apparatus 10 sets the search area on the basis of one of the coordinate systems to attempt to search the speaker 40 and then sets the search area on the basis of the other of the coordinate systems to attempt to search the speaker 40. Then, the control section 11 of the information processing apparatus 10 may choose the one including a greater number of areas on which the speakers 40 can be searched.

Note that the present technology may also have the following structures.

(1) An information processing apparatus, including:

a control section that selects a speaker to be used when a projection is performed on a specified projection area from a plurality of speakers on the basis of information about the specified projection area and information about positions of the plurality of speakers from a plurality of projection areas capable of projecting an image.

(2) The information processing apparatus according to (1), in which

the control section selects the speaker to be used on the basis of a distance between the specified projection area and each speaker.

(3) The information processing apparatus according to (2), in which

the control section selects a speaker that has a distance closest to the specified projection area as the speaker to be used from the plurality of speakers.

(4) The information processing apparatus according to any one of (1) to (3), in which

the control section selects two or more speakers as the speaker to be used.

(5) The information processing apparatus according to (4), in which

different voice channels are allocated to the respective two or more speakers.

(6) The information processing apparatus according to (5), in which

the control section sets a plurality of search areas for searching the speaker and selects a speaker to be used for each search area.

(7) The information processing apparatus according to (6), in which

the control section sets the plurality of search areas using a position of the specified projection area as a reference.

(8) The information processing apparatus according to any one of (1) to (7), in which

the control section acquires information about a position of a user and selects the speaker to be used on the basis of the information about the position of the user.

(9) The information processing apparatus according to (8), in which

the control section acquires information about each audible area of the plurality of speakers and selects the speaker to be used on the basis of the information about each audible area.

(10) The information processing apparatus according to (9), in which

the control section determines whether or not the speaker including the position of the user in the search area is present, and, if present, selects the speaker including the position of the user in the search area as the speaker to be used.

(11) The information processing apparatus according to (10), in which

if the speaker including the position of the user in the search area is not present, the control section selects the speaker that has the distance closest to a projection area from the plurality of speakers as the speaker to be used.

(12) The information processing apparatus according to any one of (8) to (11), in which

the control section selects two or more speakers as the speaker to be used.

(13) The information processing apparatus according to (12), in which

the control section sets a plurality of search areas for searching the speaker and selects the speaker to be used for each search area.

(14) The information processing apparatus according to (13), in which

the control section sets the plurality of search areas on the basis of the positions of the user.

(15) The information processing apparatus according to any one of (1) to (14), in which

each of the plurality of speakers has a marker for acquiring the information about the position of the speaker.

(16) The information processing apparatus according to any one of (1) to (15), in which

at least one speaker of the plurality of speakers is capable of being held by a user, and

the control section acquires the information about the position of the speaker held by the user and registers the projection area on the basis of the information about the position of the speaker.

(17) The information processing apparatus according to any one of (1) to (16), in which

the control section changes the position of the projection area.

(18) An information processing system, including:

a plurality of speakers; and

an information processing apparatus, including

a control section that selects a speaker to be used when a projection is performed on a specified projection area from the plurality of speakers on the basis of information about the specified projection area and information about positions of the plurality of speakers from a plurality of projection areas capable of projecting an image.

(19) An information processing method, including:

selecting a speaker to be used when a projection is performed on a specified projection area from the plurality of speakers on the basis of information about the specified projection area and information about positions of the plurality of speakers from a plurality of projection areas capable of projecting an image.

(20) A program to function a computer as a control section that selects a speaker to be used when a projection is performed on a specified projection area from a plurality of speakers on the basis of information about the specified projection area and information about positions of the plurality of speakers from a plurality of projection areas capable of projecting an image.

### REFERENCE SIGNS LIST

10 information processing apparatus
20 projector
30 camera
40 speaker
100 information processing system

1. An information processing apparatus, comprising:
a control section that selects a speaker to be used when a projection is performed on a specified projection area from a plurality of speakers on a basis of information about the specified projection area and information about positions of the plurality of speakers from a plurality of projection areas capable of projecting an image.

2. The information processing apparatus according to claim 1, wherein
the control section selects the speaker to be used on a basis of a distance between the specified projection area and each speaker.

3. The information processing apparatus according to claim 2, wherein
the control section selects a speaker that has a distance closest to the specified projection area as the speaker to be used from the plurality of speakers.

4. The information processing apparatus according to claim 1, wherein
the control section selects two or more speakers as the speaker to be used.

5. The information processing apparatus according to claim 4, wherein
different voice channels are allocated to the respective two or more speakers.

6. The information processing apparatus according to claim 5, wherein
the control section sets a plurality of search areas for searching the speaker and selects a speaker to be used for each search area.

7. The information processing apparatus according to claim 6, wherein
the control section sets the plurality of search areas using a position of the specified projection area as a reference.

8. The information processing apparatus according to claim 1, wherein
the control section acquires information about a position of a user and selects the speaker to be used on a basis of the information about the position of the user.

9. The information processing apparatus according to claim 8, wherein
the control section acquires information about each audible area of the plurality of speakers and selects the speaker to be used on a basis of the information about each audible area.

10. The information processing apparatus according to claim 9, wherein
the control section determines whether or not the speaker including the position of the user in the search area is present, and, if present, selects the speaker including the position of the user in the search area as the speaker to be used.

11. The information processing apparatus according to claim 10, wherein
if the speaker including the position of the user in the search area is not present, the control section selects the speaker that has the distance closest to a projection area from the plurality of speakers as the speaker to be used.

12. The information processing apparatus according to claim 8, wherein
the control section selects two or more speakers as the speaker to be used.

13. The information processing apparatus according to claim 12, wherein
the control section sets a plurality of search areas for searching the speaker and selects the speaker to be used for each search area.

14. The information processing apparatus according to claim 13, wherein
the control section sets the plurality of search areas on a basis of the positions of the user.

15. The information processing apparatus according to claim 1, wherein
each of the plurality of speakers has a marker for acquiring the information about the position of the speaker.

16. The information processing apparatus according to claim 1, wherein
at least one speaker of the plurality of speakers is capable of being held by a user, and
the control section acquires the information about the position of the speaker held by the user and registers the projection area on a basis of the information about the position of the speaker.

17. The information processing apparatus according to claim 1, wherein
the control section changes the position of the projection area.

18. An information processing system, comprising:
a plurality of speakers; and
an information processing apparatus, including
a control section that selects a speaker to be used when a projection is performed on a specified projection area from the plurality of speakers on a basis of information about the specified projection area and information about positions of the plurality of speakers from a plurality of projection areas capable of projecting an image.

19. An information processing method, comprising:
selecting a speaker to be used when a projection is performed on a specified projection area from the plurality of speakers on a basis of information about the specified projection area and information about positions of the plurality of speakers from a plurality of projection areas capable of projecting an image.

20. A program to function a computer as a control section that selects a speaker to be used when a projection is performed on a specified projection area from a plurality of speakers on a basis of information about the specified projection area and information about positions of the plurality of speakers from a plurality of projection areas capable of projecting an image.
